(19) United States
(12) Patent Application Publication
(10) Pub. No.: US 2013/0220840 A1
(43) Pub. Date: Aug. 29, 2013

(54) CONTACT LENS CASE WITH REMOVABLE TOPS AND METHODS

(71) Applicants: Robert N. Priebe, Bloomington, MN (US); Eric Bombardt, Inver Grove Heights, MN (US); Candice Thomas, Lakeville, MN (US)

(72) Inventors: Robert N. Priebe, Bloomington, MN (US); Eric Bombardt, Inver Grove Heights, MN (US); Candice Thomas, Lakeville, MN (US)

(21) Appl. No.: 13/408,602

(22) Filed: Feb. 29, 2012

(51) Int. Cl. A45C 11/00; B23P 11/00; B65D 85/00; B65D 81/22

(52) U.S. Cl. 206/5.1; 220/256.1; 29/428

(57) ABSTRACT

A contact lens case assembly includes a base having at least a first well and at least a first lid removeably connected to selectively cover and expose the first well. At least a first decorative cover member is removeably and replaceably attached to the first lid. The assembly can also include a second well, a second lid, and a second decorative cover member. A projection-receiver arrangement between the decorative cover member and the lid helps to attach the cover member to the lid.

### TECHNICAL FIELD

This disclosure relates to contact lens cases. Specifically, this disclosure relates to contact lens cases having removable and replaceable decorative cover members, kits for such use, and methods of use.

### BACKGROUND

Contact lens cases are made to hold and store contact lenses. Generally, contact lens cases are marked in a manner that allows the wearer to distinguish between the left lens and the right lens.

Many contact lens cases look alike. If multiple members of a family wear contact lenses, it may be difficult to not mix up the cases between family members. For example, if all of the contact lens cases were stored in the same bathroom of a house, they could be easily confused.

Some people may desire to customize the appearance of their contact lens case. They may wish to customize it, and frequently change the appearance, based upon changing tastes or societal trends. Improvements in contact lens cases are desired to allow for such customization.

### SUMMARY

The present disclosure provides a contact lens case assembly for allowing the user to customize the appearance of the lens case.

In one aspect, a contact lens case assembly is provided including a base having at least a first well sized to accommodate a contact lens, and at least a first lid removeably connected to selectively cover and expose the first well. At least a first decorative cover member is removeably and replaceably attachable to the first lid.

In another aspect, a cover member for removable attachment to a contact lens case lid is provided. The cover member includes a lid-facing surface and an opposite outer surface. The cover member also includes an outer wall projecting from the outer surface to circumscribe the lid-facing surface. A connector extends from the lid-facing surface constructed and arranged to be removeably attached to a contact lens case lid.

In another aspect, a method of using a contact lens case is provided. The method includes a step of providing a contact lens case having a base with at least a first well, sized to accommodate a contact lens, and at least a first lid removeably connected to cover the first well. The method further includes a step of removeably attaching a decorative cover to the first lid.

In another aspect, a kit is provided. The kit includes a contact lens case, including a base having at least first and second wells, each sized to accommodate a contact lens, and at least first and second lids removeably connected to selectively cover and expose the first and second wells. The kit also includes a plurality of decorative cover members constructed and arranged to removeably attach to the first lid and second lid.

A variety of examples of desirable product features or methods are set forth, in part, in the description that follows, and in part, will be apparent from the description, or may be learned by practicing various aspects of the disclosure. The aspects of the disclosure may relate to individual features as well as combinations of features. It should be understood that both the forgoing general description and the following detailed description are explanatory only, and are not restrictive of the claimed invention.

There is no specific requirement that the components, features, or assemblies include all of the features depicted and techniques disclosed in order to obtain some advantage. In general, selected use of the features or methods, without the use of others, can still lead to advantageous systems.

### BRIEF DESCRIPTION OF THE DRAWINGS

FIG. 1 is an exploded, perspective view of one embodiment of a contact lens case assembly, constructed in accordance with principles of this disclosure;

FIG. 2, is a perspective view of the contact lens case assembly of FIG. 1, but in an assembled position;

FIG. 3 is an end view of the contact lens case assembly of FIG. 2;

FIG. 4 is an end view of the contact lens case assembly of FIG. 2, the opposite end than that shown in FIG. 3;

FIG. 5 is a partially exploded, perspective view of the contact lens case assembly of FIG. 1;

FIG. 6 is a front view of the contact lens case assembly of FIG. 2;

FIG. 7 is a cross sectional view of the contact lens case assembly of FIG. 6, the cross section being taken along the line 7-7 of FIG. 6;

FIG. 8 is a top view of the contact lens case assembly of FIG. 2;

FIG. 9 is a cross sectional view of the contact lens case assembly of FIG. 8, the cross section being taken along the line 9-9 of FIG. 8;

FIG. 10 is a bottom view of a cover member used in the contact lens case assembly of FIG. 1;

FIG. 11 is a top view of an alternate embodiment of a geometric object used as part of a projection-receiver arrangement in the contact lens case assembly of FIG. 1;

FIG. 12 is a top view of another alternate embodiment of a geometric object for a projection-receiver arrangement; and

FIG. 13 is a top view of another embodiment of a geometric object usable as part of a projection-receiver arrangement.

### DETAILED DESCRIPTION

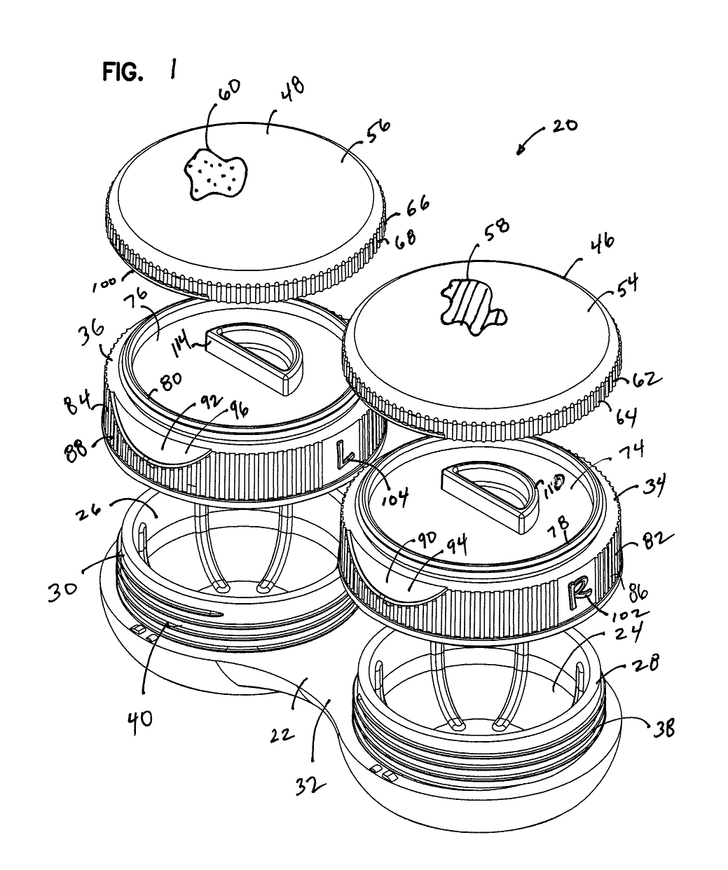

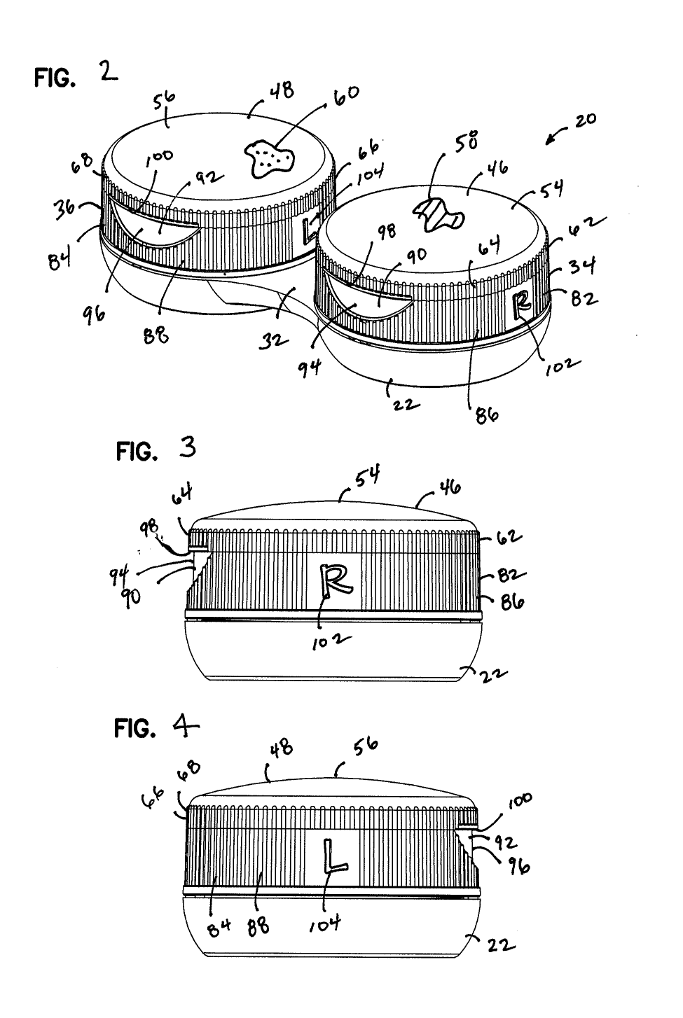

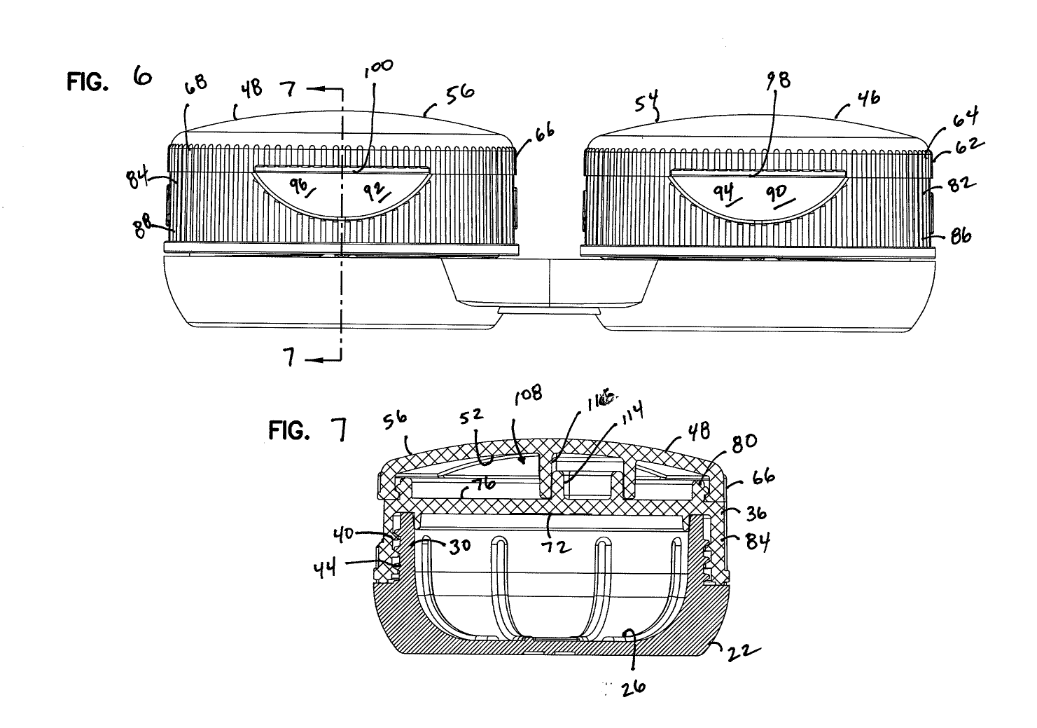

A contact lens case assembly is shown in FIGS. 1-9 at reference numeral 20. In general, the assembly 20 includes a base 22. The base 22 has at least a first well 24 sized to accommodate a contact lens. In the embodiment shown, the base 22 also includes a second well 26, also sized to accommodate a contact lens.

The first and second wells 24, 26 each includes a cylindrical wall 28, 30 circumscribing or surrounding the wells 24, 26. The wells 24, 26 are connected by a bridge region 32.

The assembly 20 further includes at least a first lid 34. The first lid 34 is removeably connectable to selectively cover and expose one of the first and second wells 24, 26. In the embodiment shown, the assembly 20 also includes a second lid 36. The second lid 36 is removeably connectable to selectively cover and expose one of the first and second wells 24, 26.

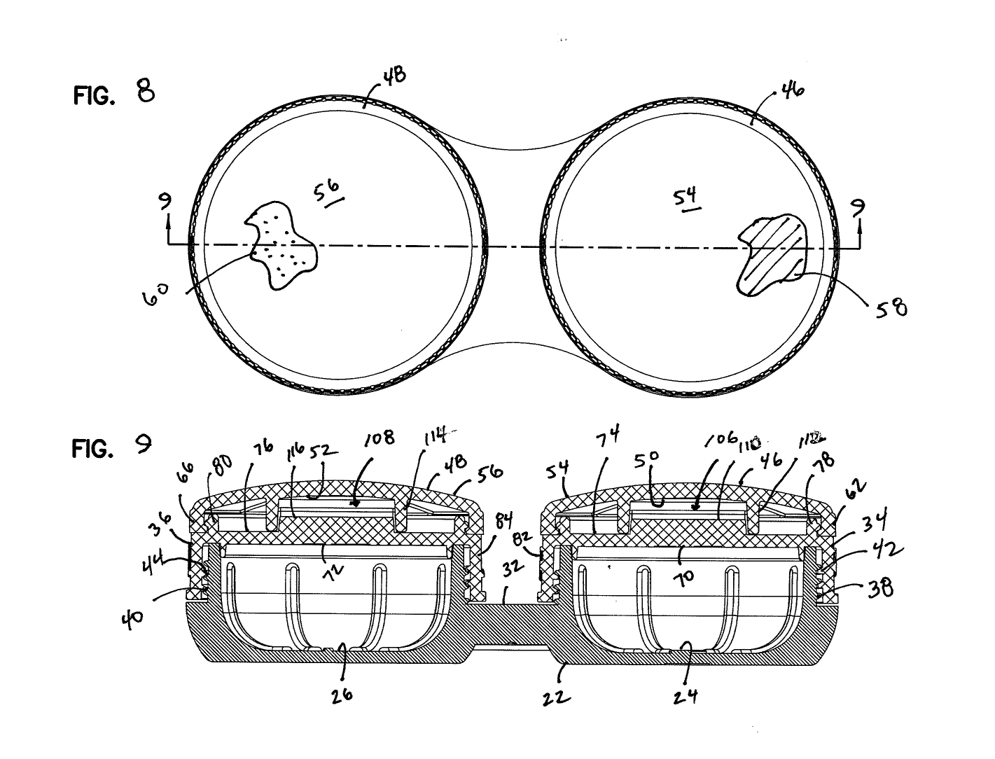

A variety of ways of attaching the lids 34, 36 to cover the wells 24, 26 are possible. In the example embodiment shown, the lids 34, 36 are connectable to cover the wells 24, 26 through a threaded connection. For example, in FIG. 1, each of the walls 28, 30 include threads 38, 40 on the external side of the walls 28, 30, which mate with internal threads 42, 44 (FIG. 9) on the first and second lids 34, 36.

The first and second lids 34, 36, in the embodiment shown, include a surrounding wall 82, 84. Each of the surrounding walls 82, 84, in the embodiment shown, includes the threads 42, 44, mentioned previously along the inner side of the walls 82, 84. Along the exterior of the surrounding walls 82, 84 are optional vertical serrations 86, 88 to help with grip and to enhance the decorative appearance.

The contact lens case assembly 20 further includes at least a first cover member 46. The first cover member 46 is removeably and replaceably attached to one of the first or second lids 34, 36. By the term “removeably and replaceably attached,” it is meant that the cover member 46 can be removed from the lids 34, 36 without destroying either the cover member 46 or the lids 34, 36. It is also meant that it can again be reused and operably oriented again on one of the lids 34, 36 without destruction. Preferably, the cover member 46 is removeably and replaceable from the lids 34, 36 without the use of tools, although it may be possible in other embodiments.

In the example shown in FIG. 1, the assembly 20 further includes a second cover member 48. The second cover member 48 is removeably and replaceably attached to one of the first and second lids 34, 36.

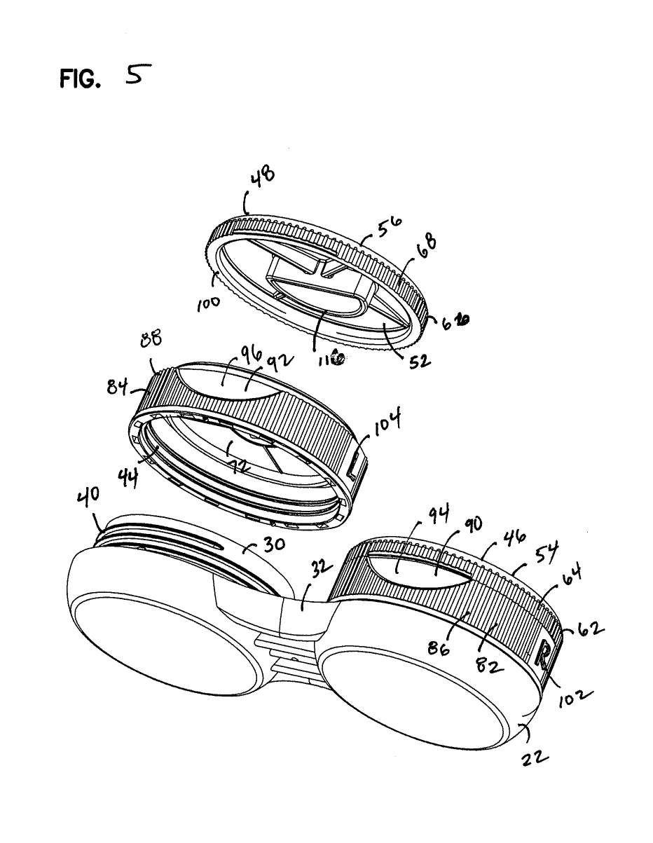

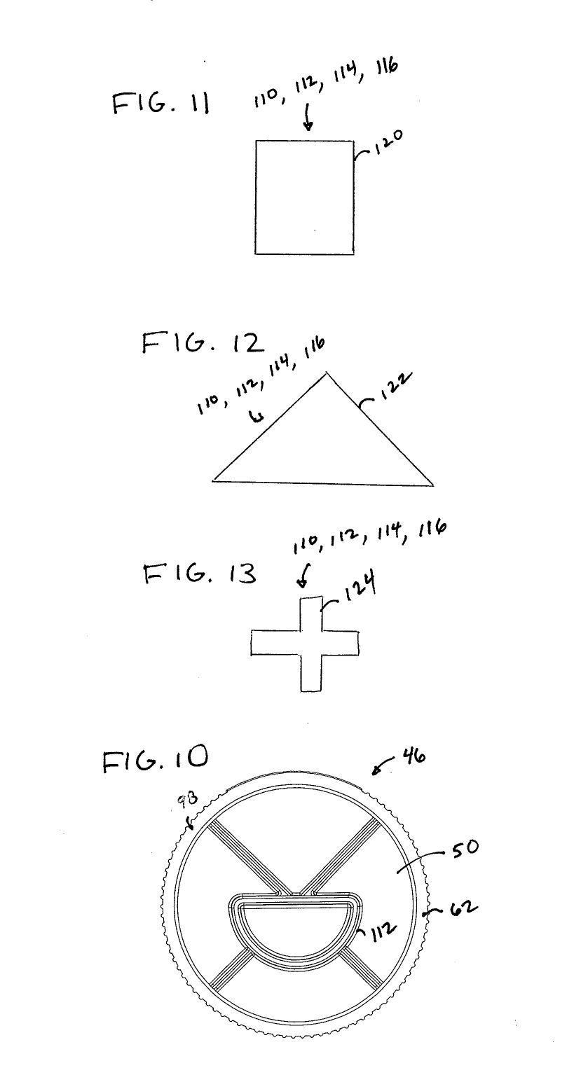

The first cover member 36 includes a lid-facing surface 50 (FIG. 10). Analogously, the second cover member 48 includes a lid-facing surface 52 (FIG. 5). Opposite of the lid-facing surfaces 50, 52 is an opposite outer surface 54, 56.

In preferred embodiments, the outer surfaces 54, 56 include a decoration or decorative appearance 58, 60. The decorations 58, 60 are shown schematically, and only partially in FIG. 1. It should be understood that decorations, 58, 60 can take many different appearances including colors, designs, pictures, photos, symbols, astrological signs, glow-in-the-dark colors, etc. These decorations 58, 60 can either be in the form of two-dimensional images, or can have three-dimensional appearances. In typical use, the decorations 58, 60 will appear different from each other, but they may also be identical to each other in appearance.

The first cover member 46 includes an outer wall 62 projecting from the outer surface 54 to circumscribe the lid-facing surface 50. In the embodiment shown, this outer wall 62 is also serrated 64 about the circumference to provide enhanced grip and decorative appearance. Similarly, the second cover member 48 includes an outer wall 66 projecting from the outer surface 56 to circumscribe the lid-facing surface 52. The second cover member outer wall 66 is also shown with serrations 68, again, for both grip and decoration. The serrations 64, 68 can be omitted in other embodiments.

Each of the first lid 34 and second lid 36 includes a well-facing surface 70 (FIG. 9) and 72 (FIGS. 5 and 9). The well-facing surfaces 70, 72 face or oppose the wells 24, 26, when the lids 34, 36 are operably connected or secured to the base 22. Opposite of the well-facing surfaces 70, 72 is a cover member-facing surface 74, 76. The cover member facing surfaces 74, 76 face or oppose the cover members 46, 48.

The first and second lids 34, 36 include an upstanding wall 78, 80. The walls 78, 80 project from the cover member facing surfaces 74, 76 in a direction away from the well-facing surfaces 70, 72. When the cover members 46, 48 are operably assembled on the lids 34, 36, the upstanding walls 78, 80 and the outer walls 62, 66 are adjacent to each other. In preferred embodiments, there is a mechanical engagement, such as a snap fit between the cover member outer walls 62, 66 and the upstanding lid walls 78, 80. As can be seen in FIG. 9, in the embodiment shown, the cover member outer walls 62, 66 circumscribe and cover the lid walls 78, 80, when operably connected together. In other arrangements, it could be reversed so that the lid walls 78, 80 circumscribe and cover the cover member outer walls 62, 66.

Each of the surrounding walls, 82, 84 of the lids 34, 36 in the embodiment shown, includes a smooth, non-serrated region 90, 92. In the embodiment shown, the smooth regions 90, 92 extend from the cover member facing surfaces 74, 76 at least partially in extension down the walls 82, 84. The smooth regions 90, 92 can form cover member removal regions 94, 96. That is, the cover member removal regions 94, 96 are an area that a user can place his or her thumb or finger against and catch a bottom edge rim 98, 100 of the cover member outer walls 62, 66. When the finger catches this bottom edge rim 98, 100, the cover member 46, 48 can be snapped off or otherwise disconnected or detached from the lids 34, 36.

In the example shown in the FIGS, the cover member removal regions 94, 96 are shaped as part of one segment of a circle, including a curved line with edges connected by a straight line. Other shapes can be used.

Also, in the particular embodiment shown, each of the surrounding walls 82, 84 includes an indication 102, 104 for whether the lid 34, 36 holds the lens for the right eye or the left eye. In the embodiment shown, this indication is through a letter R on the first lid 34 and the letter L on the second lid 36.

In accordance with principles of this disclosure, the assembly 20 can include a projection-receiver arrangement removeably attaching one of the lids and one of the cover members together. In the example shown, there is a projection-receiver arrangement 106, 108 (FIG. 9), between each of the lids 34, 36 and the cover members 46, 48. In the example shown, the cover member-facing surface 74, 76 and the lid-facing surface 50, 52 include one of the projection receiver arrangements 106, 108 to attach the lids 34, 36 to one of the cover members 46, 48.

A variety of embodiments are possible. In the embodiment shown, the projection-receiver arrangement 106, 108 includes a first geometric object 110 projecting from a first one of the cover member-facing surface 74 and the lid-facing surface 50. The projection-receiver arrangement 106 also includes a second geometric object 112 projecting from a second one of the cover member-facing surface 74 and the lid-facing surface 50. The second geometric object 112 is sized to frictionally and removeably receive the first geometric object 110. In the example embodiment shown, the first geometric object 110 projects from the cover member facing surface 74 of the lid 34, while the second geometric object 112 projects from the lid-facing surface 50 of the first cover member 46.

Analogously, the projection-receiver arrangement 108 includes a first geometric object 114 projecting from a first one of the cover member-facing surface 76 and the lid-facing surface 52. The projection-receiver arrangement 108 also includes a second geometric object 116 projecting from a second one of the cover member-facing surface 76 and the lid facing surface 52. The second geometric object 116 is sized to frictionally and removeably receive the first geometric object 114. In the embodiment, the first geometric object 114 projects from the cover member facing surface 76 of the lid 36, while the second geometric object 116 projects from the lid-facing surface 52 of the cover member 48.

A variety of implementations for the projector-receiver arrangement 106, 108 are possible. In the embodiment shown, the first geometric object 110, 114 includes a semi-circle shape. Similarly, the second geometric object 112, 116 includes a semi-circle shape, sized so that it frictionally and removeably receives the first geometric object 110, 114.

Alternate shapes for the geometric objects 110, 112, 114, 116 are possible. For example, FIG. 11 shows that the geometric objects could be rectangle shaped. FIG. 12 shows that the geometric objects could be triangle shaped. FIG. 13 shows that the geometric objects could be plus-sign shaped. In each case, the corners on these objects can be rounded. Almost any shape, including symmetrical or asymmetric or irregular shape can be used. These are just examples.

The first geometric objects 110, 114, in the embodiment shown, project from the cover member facing surface 74, 76 and are shown approximately centered therewithin. In other embodiments, the first geometric objects 110 can be off-center. The first geometric objects, 110, 114 are circumscribed by the lid walls 78, 80 and in the embodiment shown, extend in height taller than the walls 78, 80. In other embodiments, they can be the same height or shorter than the lid walls 78, 80.

The second geometric objects 112, 116 extend from the lid-facing surfaces 50, 52 and are circumscribed by the outer walls 62, 66. In preferred embodiments, the cover members 46, 48 are somewhat dome-shaped, such that the outer surface 54, 56 is convex, while the lid-facing surface 50, 52 is concave. In the embodiment shown, because the second geometric objects 112, 116 are on the concave portion of the lid-facing surface 50, 52, the second geometric objects 112, 116 do not extend past the outer walls 62, 66 in height. In other embodiments, they could be taller in height than the outer walls 62, 66.

In general, the first and second cover members 46, 48 each has a first outermost dimension. In the embodiment shown, this is a diameter. The outer wall 62, 66 of each of the cover members 46, 48 has a height or length extending from the respective outer surface 54, 56 to a free end, corresponding to the bottom edge rim 98, 100. In general, a ratio of the outermost dimension of the cover member 46, 48 to the length of the outer wall 62, 66 is between 10:1 and 15:1. Preferably, the cover member 46, 48 has an outer perimeter that is generally circular having a diameter between 0.8-1.5 inches. Preferably, the second geometric object 112, 116, corresponding to a connector extending from the lid-facing surface 50, 52 projects a distance of about 0.1-0.2 inches from the lid-facing surface 50, 52. The connector, corresponding to the second geometric objects 112, 116 is constructed and arranged to be removeably attached to one of the contact lens case lids 34, 36.

A method of using a contact lens case can be applied using the principles herein. In one example, the method includes a step of providing a contact lens case having a base with at least a first well sized to accommodate a contact lens and at least a first lid removeably connected to cover the first well. In one example, this can include providing the contact lens case 20 having base 22 with first well 24. The first lid 34 can be removeably connected to cover the first well 24.

The method also includes a step of removeably attaching a decorative cover to the first lid. In one example, this can include removeably attaching one of the cover members 46, 48 to the first lid 34.

In one example, the step of removeably attaching a decorative cover includes engaging a projection-receiving arrangement between the decorative cover and the first lid. For example, this step can include engaging the first projection-receiver arrangement 106 between the cover member 46 and the first lid 34. In one example, this can include aligning the first geometric object 110 with the second geometric object 112, such that the first geometric object 110 is received in and frictionally held by the second geometric object 112.

The method can include the step of providing a contact lens case that includes both first and second wells and first end and second lids removeably connected to each cover a respective first and second well. In the example shown, this can include providing the assembly 20 in which first and second wells 24, 26 and first and second lids 34, 36 are removeably connected to each cover one of the wells 24, 26. The step of removeably attaching a decorative cover to the first lid can include also removeably attaching a second decorative cover to the second lid. For example, this can include removeably attaching second cover member 48 to the second lid 36.

A kit can be provided including the assembly shown in FIG. 1. The kit can include the contact lens case having base 22 and at least first and second lids 34, 36. A plurality of decorative cover members, such as cover members 46, 48, can be provided in the kit. In addition, more than just two cover members can be provided. It is contemplated that several or many cover members that are different in decoration can be provided in the kit. In this way, the user can periodically, selectively change the appearance of the lids 34, 36, based upon which cover member he removeably attaches to the lids 34, 36.

The above represents example principles. Many embodiments can be made according to these principles.

What is claimed is:

1. A contact lens case assembly comprising:
(a) a base having at least a first well sized to accommodate a contact lens;
(b) at least a first lid removably connected to selectively cover and expose the first well; and
(c) at least a first decorative cover member removably and replaceably attached to the first lid.

2. An assembly according to claim 1 further comprising:
(a) a projection-receiver arrangement removably attaching the first lid and the first cover member together.

3. An assembly according to claim 1 wherein:
(a) the first lid includes a well-facing surface and an opposite cover member-facing surface;
(b) the first cover member includes a lid-facing surface and an opposite outer surface; and
(c) the cover member-facing surface and the lid-facing surface include a projection-receiver arrangement removably attaching the first lid and the first cover member together.

4. An assembly according to claim 3 wherein:
(a) the first lid includes an upstanding wall projecting from the cover member-facing surface along an outer perimeter in a direction away from the well-facing surface; and
(b) the first cover member includes an outer wall projecting from the outer surface to circumscribe the lid-facing surface;
(i) the upstanding wall of the first lid and the outer wall of the first cover member being adjacent when the first cover member is attached to the first lid.

5. An assembly according to claim 3 wherein:
(a) the projection-receiver arrangement includes:
(i) a first geometric object projecting from a first one of the cover member-facing surface and the lid-facing surface; and
(ii) a second geometric object projecting from a second one of the cover member-facing surface and the lid-facing surface;
wherein the second geometric object is sized to frictionally and removably receive the first geometric object.

6. An assembly according to claim 5 wherein:
(a) the first geometric object includes one of a rectangle-shape; a semi-circle shape; a triangle-shape; and a plus-sign shape.

7. An assembly according to claim 1 further comprising:
(a) a second well in the base sized to accommodate a contact lens;
(b) a second lid removably connected to selectively cover and expose the second well; and
(c) a second decorative cover member removably attached to the second lid.

8. An assembly according to claim 7 further comprising:
(a) a first projection-receiver arrangement removably attaching the first lid and the first cover member together; and
(b) a second projection-receiver arrangement removably attaching the second lid and the second cover member together.

9. A cover member for removable attachment to a contact lens case lid; the cover member comprising:
(a) a lid-facing surface and an opposite outer surface;
(b) an outer wall projecting from the outer surface to circumscribe the lid-facing surface; and
(c) a connector extending from the lid-facing surface constructed and arranged to be removably attached to a contact lens case lid.

10. A cover member according to claim 9 wherein:
(a) the cover member has a first outermost dimension;
(b) the outer wall has a total length from the outer surface to a free end; and
(c) a ratio of the first outermost dimension and the total length of the outer wall is between 10:1 and 15:1.

12. A cover member according to claim 9 wherein:
(a) the outer surface is convexly curved.

13. A cover member according to claim 9 wherein:
(a) the cover member has an outer perimeter that is generally circular having a diameter between 0.8-1.5 inches.

14. A cover member according to claim 9 wherein:
(a) the connector includes a geometric object projecting a distance of 0.1-0.2 inch from the lid-facing surface.

15. A cover member according to claim 14 wherein:
(a) the geometric object includes one of a rectangle-shape; a semi-circle shape; a triangle-shape; and a plus-sign shape.

16. A method of using a contact lens case; the method comprising:
(a) providing a contact lens case having a base with at least a first well sized to accommodate a contact lens and at least a first lid removably connected to cover the first well; and
(b) removably attaching a decorative cover to the first lid.

17. A method according to claim 16 wherein:
(a) the step of removably attaching a decorative cover includes engaging a projection-receiver arrangement between the decorative cover and the first lid.

18. A method according to claim 16 wherein:
(a) the step of providing a contact lens case includes providing a case having a base with at least first and second wells and first and second lids removably connected to each cover a respective first and second well; and
(b) the step of removably attaching a decorative cover to the first lid includes also removably attaching a second decorative cover to the second lid.

19. A kit comprising:
(a) a contact lens case including a base having at least first and second wells each sized to accommodate a contact lens; and at least first and second lids removably connected to selectively cover and expose the first and second wells; and
(b) a plurality of decorative cover members constructed and arranged to removably attach to the first lid and second lid.

20. A kit according to claim 19 wherein:
(a) each of the decorative cover members has an outward decorative appearance different from other cover members.
